(19) United States
(12) Patent Application Publication
(10) Pub. No.: US 2024/0100879 A1
(43) Pub. Date: Mar. 28, 2024

(54) DECORATIVE SHEET AND DISPLAY DEVICE

(71) Applicant: NISSHA CO.,LTD., Kyoto (JP)

(72) Inventors: Daichi HAMA, Kyoto (JP); Tatsuo ITO, Kyoto (JP)

(73) Assignee: NISSHA CO.,LTD., Kyoto (JP)

(21) Appl. No.: 17/908,900

(22) PCT Filed: Mar. 22, 2021
(86) PCT No.: PCT/JP2021/011761

§ 371 Date: Sep. 1, 2022

(30) Foreign Application Priority Data
Apr. 2, 2020 (JP) 2020-066755

(51) Int. Cl. B44F 1/06; B44F 9/02; B60K 35/50; G02F 1/1333; G02F 1/1335; G02F 1/1347

(52) U.S. Cl. CPC B44F 1/06; B44F 9/02; B60K 35/50; G02F 1/133374; G02F 1/133512; G02F 1/13471; G09F 13/044

(57) ABSTRACT

In a decorative sheet according to the present invention, a design layer has a light passing area in which light passing through a transparent sheet is caused to pass through by a plurality of micro holes. Each of the plurality of micro holes includes a first slit and a second slit on which ink or a deposition film is not put. In each of the micro holes, the first slit and the second slit cross each other. Thus, visibility of a secondary object displayed by passing light is improved, while a reduction in quality of a primary object displayed mainly when light is not caused to pass through is prevented.

### TECHNICAL FIELD

The disclosure relates to a decorative sheet in which light passes through and a display device including the decorative sheet.

### RELATED ART

As described in Patent Literature 1, there is known an interior material having a high design property that allows a visible object (hereinafter referred to as a secondary object) different from a visible object (hereinafter referred to as a primary object) that is visible in a normal state to be visually recognized by light passing between the primary object. For example, an interior material such as Patent Literature 1, in which the primary object has a wood grain pattern and the secondary object has a gradation pattern of light and shade, allows light to pass through a fine opening to display a gradation pattern (secondary object) of light and shade, but a wood grain pattern that may be seen when light does not pass is also required to have a good appearance.

### CITATION LIST

### Patent Literature

[Patent Literature 1] Japanese Patent Lain-Open No. 2017-210011.

### SUMMARY

### Technical Problem

As described in Patent Literature 1, to display a secondary object with a large pattern (for example, a gradation pattern of light and shade by passing light) with light passing through a fine opening, visibility like conventional interior materials is sufficient. However, when a fine secondary object is displayed by the passing light or when information is conveyed by the secondary object, it is necessary to make the secondary object displayed by the passing light easy to see. However, for example, simply increasing the number of fine openings in the entire pattern in an attempt to increase the amount of passing light causes problems such as deterioration of the quality of the primary object (for example, a wood grain pattern) before the light passes through.

The disclosure improves the visibility of a secondary object such as a design displayed by the passing light while suppressing deterioration of the quality of the primary object such as a design that is mainly displayed when the light does not pass through.

### Solution to Problem

Hereinafter, multiple aspects will be described as means for solving the problem. These aspects may be combined as desired and as needed.

A decorative sheet according to an aspect of the disclosure includes: a transparent sheet; and a design layer in which a design is shown by an ink or a vapor deposition film attached to the transparent sheet. The design layer includes a light passing area in which light passing through the transparent sheet is caused to pass through by multiple microholes. Each of the microholes includes a first slit and a second slit to which the ink or the vapor deposition film is not attached, and the first slit and the second slit cross each other.

The decorative sheet configured in this way may display a pattern by the multiple microholes in addition to the design shown by the design layer. Since each of the microholes is formed by crossing the first slit and the second slit, for example, compared with a pattern displayed by dots (circular holes), it is possible to increase the brightness of each of the multiple microholes to improve the visibility of each microhole. As a result, the visibility of the pattern displayed by the multiple microholes may be improved. In addition, compared with the case of displaying with light passing through a round hole of the same size as each microhole, the area of the design layer reduced by the microhole can be reduced, so it is possible to prevent the quality of the design layer from deteriorating.

In the above-described decorative sheet, it may be configured that the first slit and the second slit each have a width of 50 μm or less and a length of 500 μm or less. The decorative sheet configured in this way makes it easy to achieve both improving the visibility of the pattern displayed by the multiple microholes, and suppressing the deterioration of the quality of the design of the design layer.

In the above-described decorative sheet, it may be configured that the design layer has a light transmittance of 20% or less in a light shielding area, which is an area other than the light passing area, and in the light passing area, the microholes are disposed so that the light transmittance is greater than the light transmittance of the light shielding area by 3% or more, but is not greater than the light transmittance of the light shielding area by 10% or more. In the decorative sheet configured in this way, since the light transmittance of the light passing area does not become greater than the light transmittance of the light shielding area by 10% or more, good visibility of the primary object when light does not pass through may be ensured. Further, since the light transmittance of the light passing area is greater than the light transmittance of the light shielding area by 3% or more, good visibility of the secondary object displayed by passing light may be ensured.

In the above-described decorative sheet, it may be configured that the first slit and the second slit are each linear, and an angle formed by the first slit and the second slit is 30 degrees or more and 90 degrees or less. The decorative sheet configured in this way tends to leave the ink or the vapor deposition film between the first slit and the second slit. In the above-described decorative sheet, it may be configured that each of the microholes includes a third slit to which the ink or the vapor deposition film is not attached so that light passing through the transparent sheet passes through, and the third slit is linear, and a midpoint of the first slit, a midpoint of the second slit, and a midpoint of the third slit are overlapped with each other, and an angle formed by the third slit and the first slit and an angle formed by the third slit and the second slit are 30 degrees or more and 90 degrees or less. As compared with a case where the microholes formed only by the first slit and the second slit are disposed, in the decorative sheet configured in this way, it becomes easy to reduce interference fringes such as moire and to improve the brightness of each microhole due to the presence of the third slit.

In the above-described decorative sheet, it may be configured that each of the microholes includes a fourth slit to which the ink or the vapor deposition film is not attached so that light passing through the transparent sheet passes through, and the fourth slit is linear, and a midpoint of the first slit, a midpoint of the second slit, a midpoint of the third slit and a midpoint of the fourth slit are overlapped with each other, and an angle formed by adjacent slits of the first slit, the second slit, the third slit, and the fourth slit is 45 degrees. The decorative sheet configured in this way makes it easy to improve the brightness of each of the microholes while reducing interference fringes such as moire due to the presence of the fourth slit.

In the above-described decorative sheet, it may be configured that the microholes are disposed side by side in a zigzag pattern. In the decorative sheet configured in this way, the microholes may be easily disposed at a high density, and it becomes easy to secure a desired light transmittance.

In the above-described decorative sheet, it may be configured that the microholes are disposed side by side in a matrix with a distance shorter than the length of the first slit. In the decorative sheet configured in this way, the microholes are disposed at a high density, and a desired light transmittance may be easily secured.

### Effects of Invention

The decorative sheet of the disclosure may improve the visibility of the secondary object displayed by the passing light while suppressing deterioration of the quality of the primary object that is mainly displayed when the light does not pass through. Further, the display device of the disclosure makes the secondary object displayed by the light passing through the microholes easier to see while suppressing the deterioration of the quality of the primary object which is mainly responsible for the decoration when the light does not pass through.

### BRIEF DESCRIPTION OF THE DRAWINGS

FIG. 1 is a perspective view of the center console with the built-in display device in which light passes through.

FIG. 2 is a perspective view of the center console with the built-in display device in which light does not pass through.

FIG. 3 is a schematic view for illustrating an outline of the display device.

FIG. 4 is an enlarged plan view of a decorative sheet for illustrating an example of a microhole.

FIG. 5 is an enlarged plan view of a decorative sheet for illustrating another example of a microhole.

FIG. 6 is a conceptual view of two-dimensional data showing an irradiation area of a laser beam with respect to the microhole of FIG. 4.

FIG. 7 is a conceptual view of two-dimensional data showing an irradiation area of a laser beam with respect to the microhole of FIG. 5.

FIG. 8 is a drawing substitute photograph showing a processing example of the microhole of FIG. 4.

FIG. 9 is a drawing substitute photograph showing a processing example of the microhole of FIG. 5.

FIG. 10 is an enlarged plan view showing an example of a decorative sheet according to the modified example A.

FIG. 11 is an enlarged plan view showing another example of a decorative sheet according to the modified example A.

FIG. 12 is an enlarged plan view showing an example of a decorative sheet having multiple circular holes.

FIG. 13 is a schematic cross-sectional view of a decorative sheet showing an example of the cross-sectional structure of the decorative sheet.

FIG. 14 is a drawing substitute photograph showing letters displayed in a light passing area formed by multiple circular holes.

FIG. 15 is a drawing substitute photograph showing letters displayed in a light passing area formed by asterisk-shaped microholes.

### DESCRIPTION OF THE EMBODIMENTS

### (1) Overall Configuration

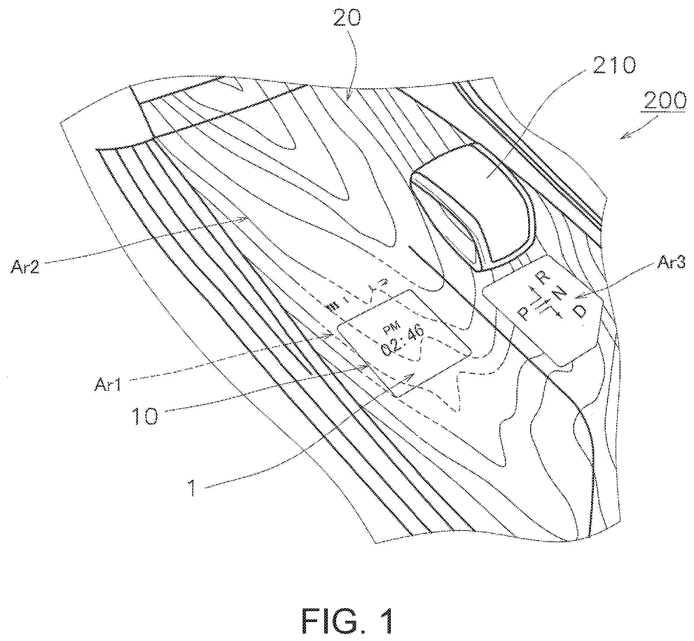

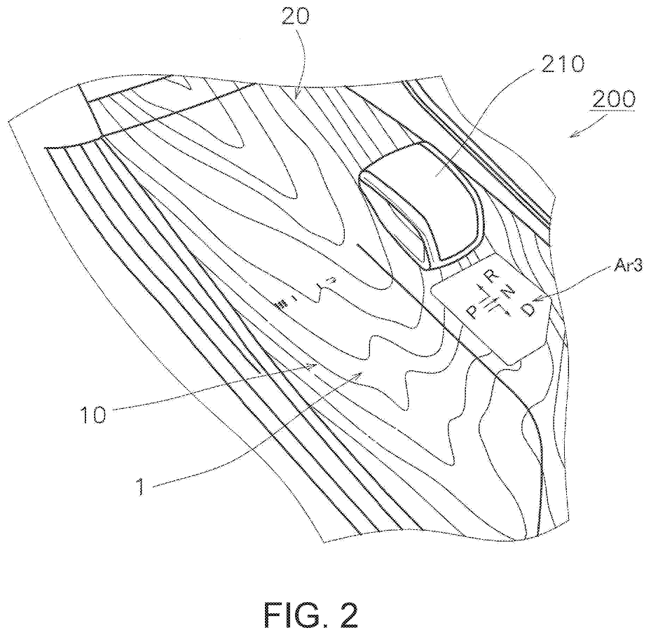

FIGS. 1 and 2 show a display device 1 according to an embodiment of the disclosure. Here, the display device 1 attached to a center console 200 of an automobile is given as an example. A decorative sheet 20 having a wood grain pattern is attached to many parts of the center console 200. The decorative sheet 20 is one of the configuring elements configuring the display device 1. This wood grain pattern is the primary object. Here, a case where the primary object has a wood grain pattern is described, but the primary object is not limited to a design such as a wood grain pattern. The primary object may be, for example, a symbol or a shape for conveying information.

A screen 10 of the display device 1 is disposed below the decorative sheet 20. In other words, the screen 10 is disposed so that the irradiated light passes through the decorative sheet 20. The time of 2:46 pm is displayed on this screen 10. In the screen 10, the letters “PM” and the numbers “02” and “46” indicating the time are shining. These letters and numbers are the secondary object. Here, a case where the secondary object is a sign such as a letter and a number is described, but the secondary object may be, for example, a design or a signal for decoration, and is not limited to a symbol or a shape for conveying information.

In FIG. 1, the portion where the wood grain pattern of the decorative sheet 20 is shown by the broken line is the light passing area Ar1. In FIG. 1, the portion where the wood grain pattern of the decorative sheet 20 is shown by the solid line is the light shielding area Ar2. By having the light passing area Ar1 of the decorative sheet 20, the display device 1 may switch between two objects having different appearances. When the display on the screen 10 of the display device disappears, as shown in FIG. 2, only the wood grain pattern of a design layer 22 of the decorative sheet 20 is visually recognized.

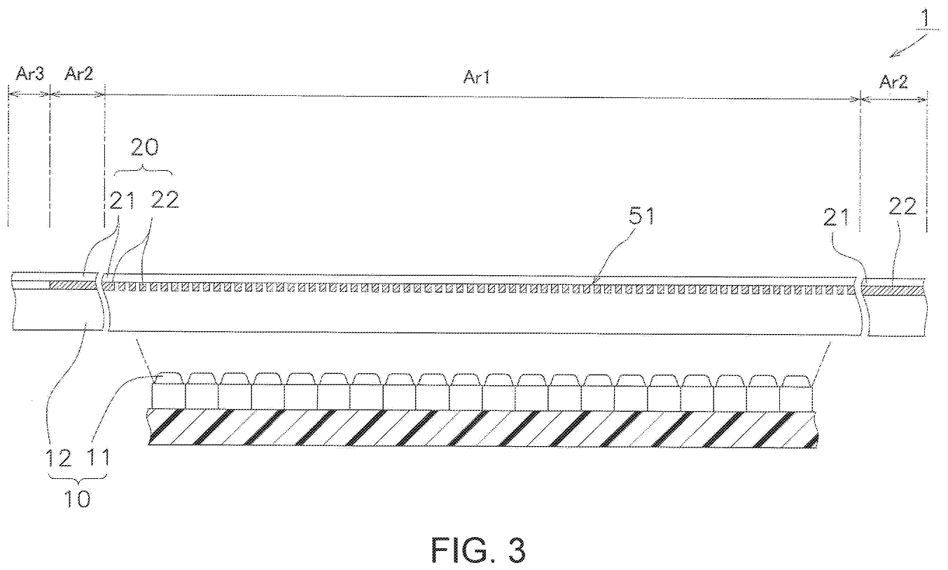

FIG. 3 shows an outline of a configuration example of the display device 1. The display device 1 includes the screen 10 having multiple light sources 11 disposed in a matrix and a transparent protective plate 12. For the multiple light sources 11, for example, multiple LEDs may be used. Further, a transparent sheet 21 and the decorative sheet 20 having the design layer 22 on which the design is printed with ink are provided. The design layer 22 has multiple microholes 51 in the entire light passing area Ar1 through which light passes. In the light passing area Ar1, the light passing through the transparent sheet 21 passes through the multiple microholes 51. Each microhole 51 includes a first slit 231 and a second slit 232 where ink is not attached. The first slit 231 and the second slit 232 cross each other and extend in different directions. When each of the multiple microholes 51 through which the light of the light sources 11 passes includes a first slit and a second slit that cross each other, compared with the case where multiple slits extending in the same direction are disposed in the light passing area, it is possible to reduce problems due to the occurrence of interference fringes such as moire.

In the microhole 51 shown in FIG. 3, the angle formed by the first slit 231 and the second slit 232 is 90 degrees. In other words, the microhole 51 is the intersection of the first slit 231 and the second slit 232. When the first slit 231 and the second slit 232 configuring the microhole 51 are linear, the angle formed by the first slit 231 and the second slit 232 is preferably 30 degrees or more and 90 degrees or less. It is preferable that the first slit 231 and the second slit 232 have a width of 50 μm or less and a length of 500 μm or less, respectively.

The light emitted from the screen 10 disposed on the back side of the light passing area Ar1 of the decorative sheet 20 passes through each microhole 51 and is radiated to the outside of the decorative sheet 20. As shown in FIG. 1, the display device 1 illuminates, for example, the light sources 11 at the portion disposed in the shape of the number “2” among the multiple light sources 11 disposed in a matrix, and the number “2” indicating the time may be displayed.

The display device 1 shown in FIG. 3 has a light shielding area Ar2 having a light transmittance of 20% or less. The microhole 51 is not formed in the design layer 22 of the light shielding area Ar2. This light shielding area Ar2 means that multiple microholes 51 are not formed, and may be regarded as an area for attenuating the light passing through the transparent sheet 21 by passing through the design layer 22.

Further, the decorative sheet 20 shown in FIG. 3 has an area Ar3 in which the design layer 22 is free of ink or printed with transparent ink. The center console 200 shown in FIG. 1 is provided with a select lever 210 for an automatic transmission. The wood grain pattern of the decorative sheet 20 is not disposed in the area Ar3 in which “P,” “R,” “N” and “D” indicating the operation position (range) of the select lever 210 are displayed. On the back side of the area Ar3, for example, a metal display board on which “P,” “R,” “N” and “D” are printed is disposed.

### (2) Transmittance of Light Passing Area Ar1

In such a light passing area Ar1, it is important to ensure the visibility of the wood grain pattern of the design layer 22 which is the primary object. In order to make the wood grain pattern printed on the design layer 22 easier to see by the reflected light, it is conceivable to decrease the number and size of the microholes 51 to increase the area where the ink of the design layer 22 reflects the light. In other words, in order to increase the reflected light of the wood grain pattern of the design layer 22, it is preferable to suppress the decrease in the area of the design layer 22 where the ink is not attached by the first slit 231 and the second slit 232 of the multiple microholes 51.

Further, in the light passing area Ar1, it is important to ensure the visibility of the time display of the screen 10 which is the secondary object. In order to make the display by the multiple light sources 11 easier to see by the passing light, it is conceivable to increase the number and size of the microholes 51 to increase the transmittance of the light of the light sources 11 that passes through the design layer 22 and is visually recognized. In order to increase the amount of passing light passing through the multiple microholes 51 of the design layer 22, it is preferable that the first slit 231 and the second slit 232 of the multiple microholes 51 increase the area of the design layer 22 where ink is not attached.

As described above, the treatment for the microholes 51 for improving the visibility of the wood grain pattern of the design layer 22 and the treatment for the microholes 51 for improving the visibility of the time display on the screen 10 are in a trade-off relationship with each other. In order to balance the visibility of both, it was found that it is preferable to set the light transmittance as follows by repeating experiments and the like. It is preferable that the light transmittance of the light shielding area Ar2 is 20% or less. Further, it is preferable that the light transmittance of the light passing area Ar1 is greater than the light transmittance of the light shielding area Ar2 by 3% or more, but not over 10% or more.

The light transmittance is measured according to the method for measuring the total light transmittance of JISK 7361 or ISO 13468. For the measurement of the transmittance in the disclosure, for example, NDH 7000, NDH 5000, or the like manufactured by Nippon Denshoku Industries Co., Ltd. are used, and the measurement diameter is φ14 mm, and the final appearance surface of the decorative sheet 20 is set on the light receiving portion side (the side of the transparent sheet 21 of FIG. 3).

### (3) Specific Disposition of Microholes

(3-1) Example of Disposition of Microholes

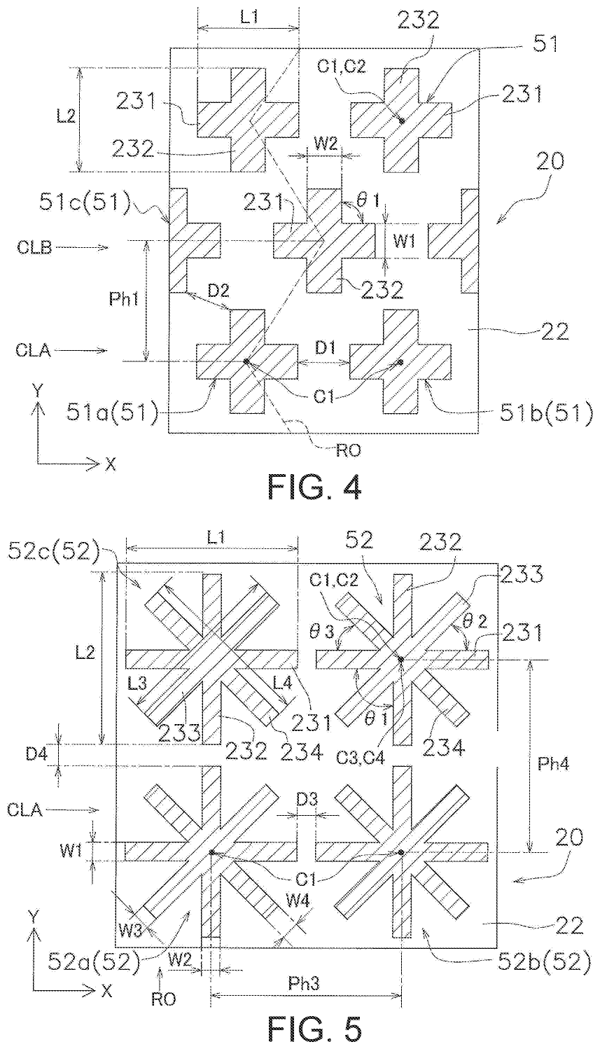

The multiple microholes 51 of the light passing area Ar1 are formed by combining the first slit 231 and the second slit 232 shown in an enlarged manner in FIG. 4. In FIG. 4, light passes through the portion indicated by the diagonal lines. In the following description, the relationship between the first slit 231 and the second slit 232 will be described using the XY coordinates shown in FIG. 4. The X-axis direction is called the row direction, and the Y-axis direction is called the column direction. In FIG. 4, the first slit 231 extends in the X-axis direction, and the second slit 232 extends in the Y-axis direction. One first slit 231 and one second slit 232 cross each other at their respective midpoints C1 and C2 to form a microhole 51. Here, a case where the angle θ1 formed by the intersecting first slit 231 and second slit 232 is 90 degrees is described. However, the angle formed by the first slit 231 and the second slit 232 may be, for example, 30 degrees or more and 90 degrees or less, and is not limited to 90 degrees. Here, a case where the angles formed by the first slit 231 and the second slit 232 of all the microholes 51 are the same is described, but the microholes 51 may be mixed in which the first slit 231 and the second slit 232 form different angles. The multiple microholes 51 shown in FIG. 4 are disposed side by side in a matrix. However, the disposition of the multiple microholes 51 may be an irregular disposition in which the microholes 51 are not disposed side by side in a matrix.

The width W1 of the first slit 231 and the width W2 of the second slit 232 are, for example, 20 μm. Here, a case where the width W1 of the first slit 231 and the width W2 of the second slit are the same is described, but the width W1 and the width W2 may be different. Here, a case where the width W1 of each first slit 231 is the same over the entire X-axis direction is described, but there may be a wide portion and a narrow portion of the width W1 in one first slit 231. Further, a case where the width W2 of each second slit 232 is the same over the entire Y-axis direction is described, but there may be a wide portion and a narrow portion of the width W2 in one second slit 232. Here, a case where the widths W1 of the multiple first slits 231 are all the same is described, but the widths W1 of the multiple first slits 231 do not have to be all the same. Here, a case where the widths W2 of the multiple second slits 232 are all the same is described, but the widths W2 of the multiple second slits 232 do not have to be all the same. In such a case, the widths W1 and W2 of the first slit 231 and the second slit 232 are defined by the widest portion.

The length L1 of the first slit 231 and the length L2 of the second slit are, for example, 60 μm. Here, a case where the length L1 of the first slit 231 and the length L2 of the second slit are the same is described, but the length L1 and the length L2 may be different. Here, a case where the lengths L1 of the multiple first slits 231 are all the same is described, but the lengths L1 of the multiple first slits 231 do not have to be all the same. Further, a case where the lengths L2 of the multiple second slits 232 are all the same is described, but the lengths L2 of the multiple second slits 232 do not have to be all the same. Here, a case where the length L1 of each first slit 231 is the same over the entire length (when the slit end is linear) is described; however, for example, there may be a long portion and a short portion in one first slit 231. The same applies to the length L2 of each second slit 232. For example, when the ink is removed by a laser, the lengths L1 and L2 are not the same over the entire length because the ends are not linear. In such a case, the lengths L1 and L2 of the first slit 231 and the second slit 232 are defined by the longest portion.

Next, the microholes 51a and 51b disposed in the same row, in other words, the microholes 51a and 51b disposed in the X-axis direction will be described. Here, a case is shown in which the distances of the midpoints C1 of the microholes 51 are aligned in the X-axis direction, for example, at 90 μm. The distance D1 of the microholes 51a and 51b adjacent to each other in the X-axis direction is, for example, 30 μm.

Further, the microholes 51 are disposed in a zigzag manner along the row RO extending in the Y-axis direction. The spacing Ph1 between the rows CLA and CLB of the microholes 51 adjacent to each other is, for example, 70 μm. The distance D2 of the microholes 51a and 51c adjacent to each other in the Y-axis direction is about 27 μm.

As described above, both the distance D1 of the microholes 51a and 51b adjacent to each other and the distance D2 of the microholes 51a and 51c adjacent to each other are shorter than the lengths L1 and L2. Here, a case where the pitch of the microholes 51 disposed in a matrix in the X-axis direction and the Y-axis direction is constant is described. However, the pitches of the microholes 51 disposed in a matrix in the X-axis direction and the Y-axis direction do not have to be constant. For example, in the X-axis direction, the pitch may change so that the distance between the midpoints C1 of adjacent microholes 51 in one set may be 90 μm, and the distance between the midpoints C1 in the next set is 91 μm, and the distance between the midpoints C1 in the next set is 89 μm, and the like.

(3-2) Another Example of Disposition of Microholes

The multiple microholes in the light passing area Ar1 may be microholes 52 in which the first slit 231, the second slit 232, the third slit 233, and the fourth slit 234 are combined, which are shown enlarged in FIG. 5, in place of the microholes 51 shown in FIG. 4. In FIG. 5, light passes through the portion indicated by the diagonal lines.

In FIG. 5, the first slit 231 extends in the X-axis direction, and the second slit 232 extends in the Y-axis direction. The midpoints C1 and C2 of the first slit 231 and the second slit 232 are also the midpoints C3 and C4 of the third slit 233 and the fourth slit 234. In other words, the first slit 231, the second slit 232, the third slit 233 and the fourth slit 234 cross so that the midpoints C1, C2, C3 and C4 overlap each other. When the first slit 231 is rotated 45 degrees counterclockwise with respect to the midpoint C1, it overlaps with the third slit 233. When the first slit 231 is rotated 45 degrees clockwise with respect to the midpoint C1, it overlaps with the fourth slit 234.

Here, the angle θ1 formed by the intersecting first slit 231 and the second slit 232 is 90 degrees. In this case, the angle θ2 formed by the first slit 231 and the third slit is 45 degrees, and the angle θ3 formed by the first slit 231 and the fourth slit 234 is also 45 degrees. However, the second slit 232 in FIG. 5 may be deemed to be the third slit, and the third slit 233 may be deemed to be the second slit. When it is deemed in this way, if the first slit 231 is rotated counterclockwise by 45 degrees, it overlaps the deemed second slit (third slit 233), the deemed third slit (second slit 232), and the fourth slit 234 in this order each time it is rotated. In other words, when it is deemed in this way, the angle formed by the first slit 231 and the deemed second slit is the angle θ2. In the case shown in FIG. 5, the angle formed by the first slit and the deemed second slit is 45 degrees.

Here, a case where the angles formed by the first slit 231, the second slit 232, the third slit 233, and the fourth slit 234 of all the microholes 52 are the same is described. However, microholes 52 may be mixed in which the first slit 231, the second slit 232, the third slit 233, and the fourth slit 234 form different angles. In other words, the angles formed by the first slit 231, the second slit 232, the third slit 233, and the fourth slit 234 of all the microholes 52 do not have to be all the same. The multiple microholes 52 shown in FIG. 5 are disposed side by side in a matrix. However, the disposition of the multiple microholes 52 may be an irregular disposition in which the microholes 52 are not disposed side by side in a matrix.

For each microhole 52, the width W1 of the first slit 231, the width W2 of the second slit 232, the width W3 of the third slit 233, and the width W4 of the fourth slit 234 are, for example, 10 μm. Here, a case where the width W1 of the first slit 231, the width W2 of the second slit, the width W3 of the third slit 233, and the width W4 of the fourth slit 234 are the same for one microhole 52 is described. However, the width W1, the width W2, the width W3, and the width W4 may be different for one microhole 52. Here, a case where the width W1 of one first slit 231 is the same over the entire X-axis direction is described, but there may be a wide portion and a narrow portion of the width W1 in one first slit 231.

Here, a case where the width W1 of the first slit 231, the width W2 of the second slit, the width W3 of the third slit 233, and the width W4 of the fourth slit 234 are all the same is described. However, the width W1 of the first slit 231, the width W2 of the second slit 232, the width W3 of the third slit 233, and the width W4 of the fourth slit 234 do not have to be all the same. For example, for two different microholes 52a and 52b, the widths W1 of the first slits 231 may be different, and the widths W2 of the second slits 232 may be different, and the widths W3 of the third slits 233 may be different, and the widths W4 of the fourth slits 234 may be different.

The length L1 of the first slit 231, the length L2 of the second slit 232, the length L3 of the third slit 233 and the length L4 of the fourth slit 234 are all 90 μm, for example. Here, a case where the lengths L1, L2, L3, and L4 are the same for each microhole 52 is described. However, some or all of the lengths L1, L2, L3, L4 may be different for each microhole 52. Here, a case where the lengths L1, L2, L3, and L4 are the same over the entire slit is described, but there may be a long portion and a short portion in each microhole 52, and in that case, the length L1 of the first slit 231, the length L2 of the second slit 232, the length L3 of the third slit 233 and the length L4 of the fourth slit 234 are defined by the longest portion.

The microholes 52a and 52b disposed in the same row CLA, in other words, the microholes 52a and 52b disposed in the X-axis direction will be described. Here, a case where the spacing Ph3 of the midpoints C1 of the microholes 52 is, for example, 100 μm in the X-axis direction is shown. The distance D3 of the microholes 52a and 52b adjacent to each other in the X-axis direction is 10 μm.

Further, multiple microholes 52 are disposed along a row RO extending in the Y-axis direction. The spacing Ph4 between the midpoints C1 of the microholes 52a and 52c adjacent to each other in the same row RO is, for example, 100 μm. The distance D4 of the microholes 52a and 52c adjacent to each other in the Y-axis direction is 10 μm. The distance D3 of the microholes 52a and 52b adjacent to each other and the distance D4 of the microholes 52a and 52c adjacent to each other are shorter than the lengths L1 and L2.

In FIG. 5, the multiple microholes 52 are disposed linearly in rows and columns. However, the multiple microholes 52 may be disposed in a zigzag pattern.

### (4) Manufacturing Method of Decorative Sheet

In the first step, the design layer 22 whose design is expressed by ink or a vapor deposition film is formed on the transparent sheet 21 that is transparent with a transparency of 80% or more. The vapor deposition film is, for example, a metal vapor deposition film.

For the transparent sheet 21, for example, a resin film may be used. However, the material that may be used for the transparent sheet 21 is not limited to the resin. For example, glass may be used as the material for the transparent sheet 21.

Examples of the resin that may be used for the transparent sheet 21 include synthetic resins such as polyester resin, polypropylene resin, acrylic resin, polycarbonate resin, polyamide resin, polyimide resin, olefin resin, urethane resin, and acrylonitrile butadiene styrene resin. The thickness of the resin film used for the transparent sheet 21 is selected from, for example, in the range of 30 μm to 500 μm.

When the design of the design layer 22 is formed with ink, for example, a gravure printing method or a screen printing method may be used. The ink conventionally used in the gravure printing method or the screen printing method may be used as the ink forming the design layer 22. Such inks include, for example, resins such as acrylic resins, vinyl chloride vinyl acetate copolymer resins, thermoplastic urethane resins and polyester resins, and pigments or dyes added to the resins.

When forming a vapor deposition film on the design layer 22, for example, a vacuum vapor deposition method or a sputtering method may be used. For example, a metal vapor deposition film is vapor-deposited on the transparent sheet 21 by a vacuum vapor deposition method or a sputtering method. After the vapor deposition, for example, the metal vapor deposition film is etched to show the design. The material used for the metal vapor deposition film is, for example, aluminum, nickel, indium, tin or copper.

In the second step, the light passing area Ar1 is irradiated with a laser beam. The ink or the vapor deposition film is removed by a laser beam without making a hole in the transparent sheet 21, and multiple microholes such as the above-mentioned microholes 51 and 52 are formed in the entire light passing area Ar1. The slits formed by such a laser beam correspond to the first slit 231, the second slit 232, the third slit 233 and the fourth slit 234 of the microholes 51 and 52. The slit formed by such a laser beam preferably has a width of 50 μm or less and a length of 500 μm or less in order to reduce damage to the design layer 22.

For irradiation of the laser beam for forming the first slit 231 to the fourth slit 234, for example, CO₂ lasers, fiber lasers, YVO4 lasers or YAG lasers may be used. The wavelength of the laser beam may be selected, for example, from the range of 0.2 μm to 11 μm.

In the second step, for example, the irradiation point of the laser beam is fixed, and the transparent sheet 21 on which the design layer 22 is formed is placed on an XY stage (not shown), and the laser beam is irradiated while moving the transparent sheet 21 on the XY stage. The timing of laser beam irradiation and the movement of the XY stage are controlled by, for example, a controller (not shown). The controller is configured to include, for example, a CPU and a memory. The timing of laser beam irradiation and the trajectory of the movement of the XY stage are pre-programmed and stored in the memory of the controller.

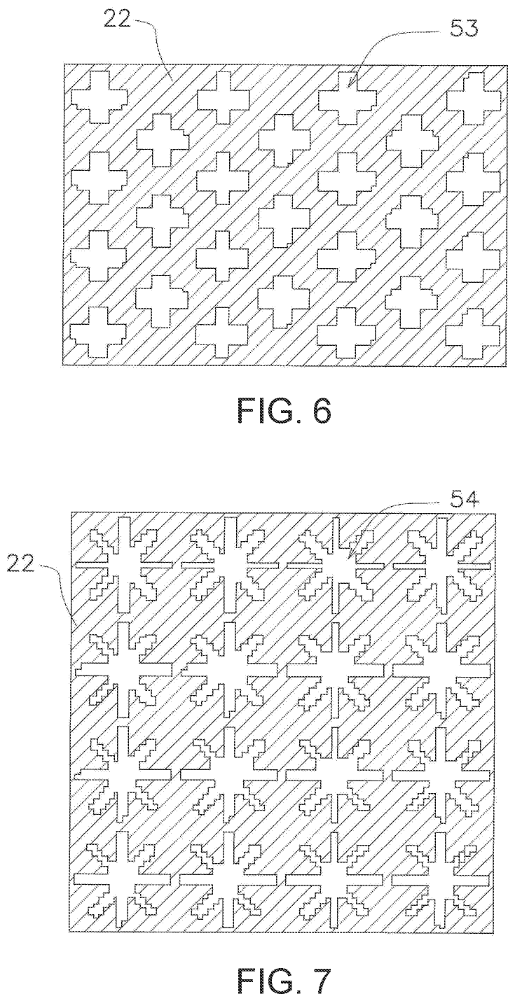

FIGS. 6 and 7 show an irradiation area after data conversion in which the irradiation area by the programmed laser beam is converted into two-dimensional data. In FIG. 6, the design layer 22 other than cross-shaped microholes 53 is shown by diagonal lines. In FIG. 7, the design layer 22 other than asterisk-shaped microholes 54 is shown by diagonal lines.

As the third step, a process other than the processes performed in the first step and the second step may be performed. As the third step, for example, in order to protect the transparent sheet 21 and the design layer 22 on which the multiple microholes 53 and 54 are formed by a laser beam, a protective layer may be formed to cover the design layer 22.

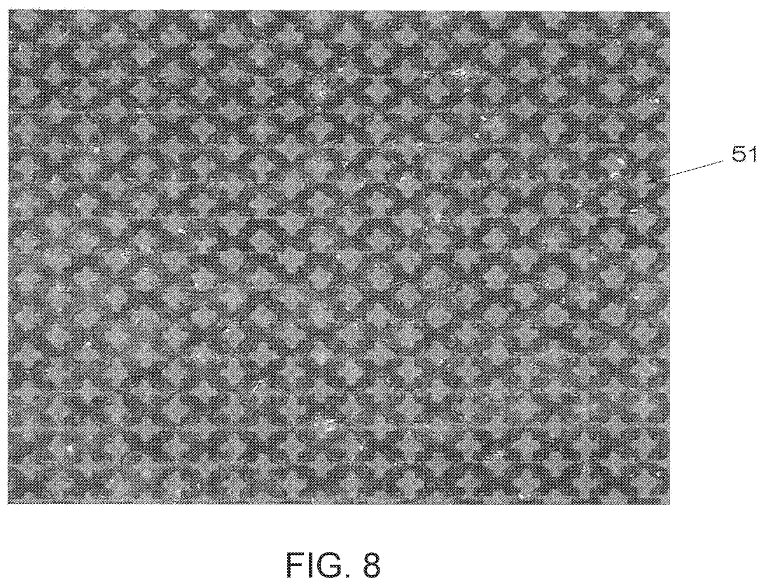

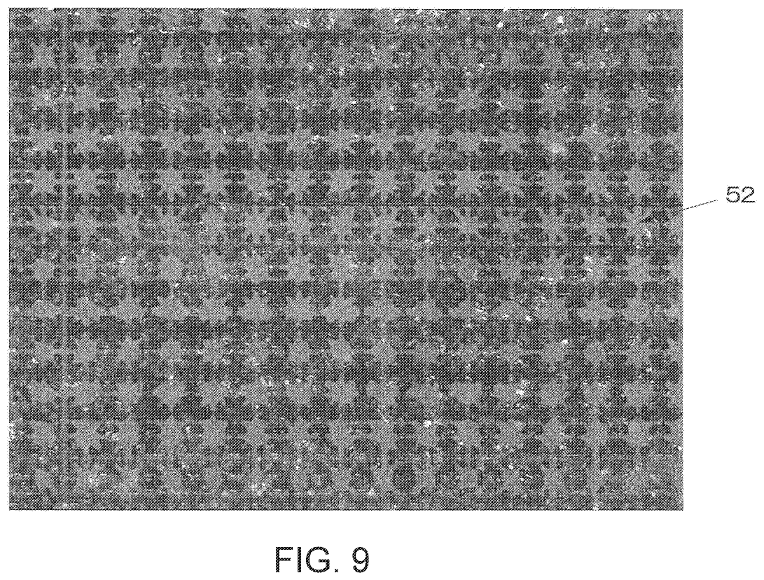

FIGS. 8 and 9 show the cross-shaped microholes 51 processed by a laser beam and the asterisk-shaped microholes 52 processed by a laser beam.

### (5) Modified Example

### (5-1) Modified Example A

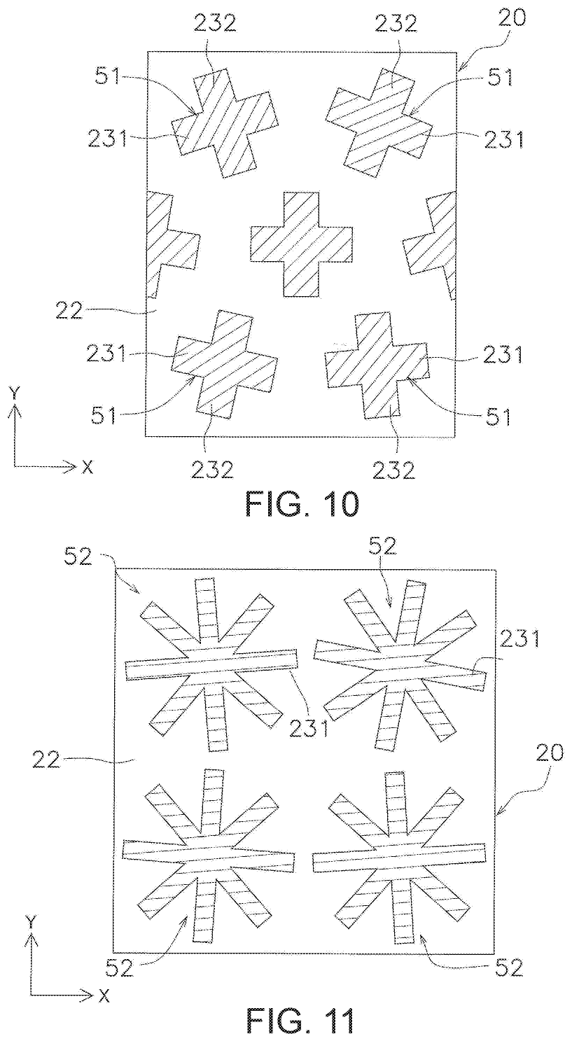

As shown in FIG. 10, the angle of the first slit 231 with respect to the X-axis direction may be individually changed for the multiple cross-shaped microholes 51. In the multiple microholes 51 shown in FIG. 10, the angle of the first slit 231 is changed with respect to the X-axis direction, but the angle formed by the first slit 231 and the second slit 232 is fixed at 90 degrees. However, the angle of the second slit 232 with respect to the X-axis direction may be individually changed and disposed for the multiple microholes 51 regardless of the first slit 231. For example, the angle of the first slit 231 with respect to the X-axis direction may be 5 degrees while the angle of the second slit 232 with respect to the X-axis direction may be 95 degrees, and the angle of the first slit 231 with respect to the X-axis direction may be 6 degrees while the angle of the second slit 232 with respect to the X-axis direction may be 98 degrees.

Further, as shown in FIG. 11, the angle of the first slit 231 with respect to the X-axis direction may be individually changed for the multiple asterisk-shaped microholes 52. In the multiple microholes 52 shown in FIG. 11, the angle of the first slit 231 is changed with respect to the X-axis direction, but the angle formed by the first slit 231 and the second slit 232, the angle formed by the first slit 231 and the third slit 233, and the angle formed by the first slit 231 and the fourth slit 234 are fixed. However, the angle of the second slit 232 with respect to the X-axis direction may be individually changed and disposed for the multiple microholes 51 regardless of the first slit 231.

### (5-2) Modified Example B

In the above embodiment, the cross-shaped microhole 51 formed by crossing the first slit 231 and the second slit 232, and the asterisk-shaped microhole 52 formed by crossing the first slit 231, the second slit 232, the third slit 233, and the fourth slit 234 have been described. However, the shape of the microholes is not limited to the shapes of the microholes 51 and 52.

For example, an asterisk-shaped microhole in which three slits are overlapped at a midpoint may be used. In this case, for example, the microhole may be configured to have a second slit rotated 60 degrees counterclockwise about the midpoint with respect to the first slit extending in the X-axis direction, and a third slit rotated 120 degrees counterclockwise about the midpoint with respect to the first slit extending in the X-axis direction.

Further, when forming a microhole, the position where the slits are overlapped is not limited to the midpoint of each other. For example, the slits may be overlapped at a point of dividing them into 2: 3. For example, the ends of the slits may be overlapped. For example, a V-shaped microhole may be formed by overlapping the ends of two slits.

Further, microholes having different shapes may be disposed in a matrix. For example, the cross-shaped microholes 51 and the asterisk-shaped microholes 52 may be disposed alternately.

### (5-3) Modified Example C

In the above embodiment, a case where the screen 10 of the display device 1 is configured by using multiple light sources 11 disposed in a matrix has been described. However, the configuration of the screen 10 is not limited to the one including such multiple light sources. The screen 10 may be configured such that, for example, a liquid crystal display and a backlight are disposed in order on the back side of the decorative sheet. In this case, if the light passing through the liquid crystal is configured to pass through the light passing area Ar1, the pattern displayed on the liquid crystal display may be displayed using the microholes 51 and 52 of the light passing area Ar1.

### (5-4) Modified Example D

In the above embodiment, the decorative sheet 20 in which the surface of the transparent sheet 21 is not formed with irregularities has been described. However, irregularities may be formed on the surface of the transparent sheet 21. In other words, the decorative sheet 20 may have a matte appearance.

### (5-5) Modified Example E

In the above embodiment, a case where the first slit 231 to the fourth slit 234 configuring the microholes 51 and 52 are linear has been described. However, the slits configuring the microhole do not have to be linear. The slits configuring the microhole may be curved, for example.

### (6) Features

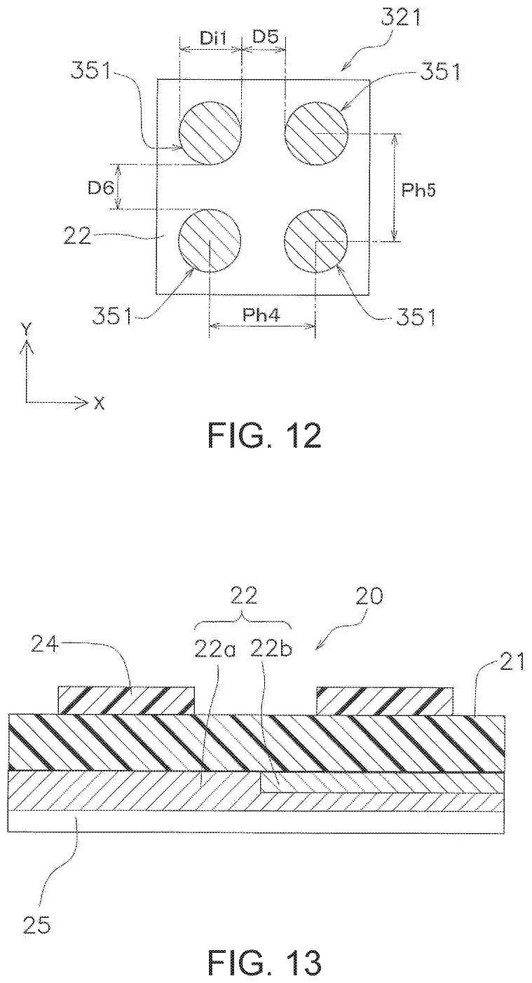

The features of the decorative sheet 20 including the first slit 231 and the second slit 232 will be described with reference to a decorative sheet 321 shown in FIG. 12. In FIG. 12, a part of the decorative sheet 321 is enlarged and shown.

The decorative sheet 321 shown in FIG. 12 has multiple circular holes 351 formed in the design layer 22. In FIG. 12, light passes through the portion indicated by diagonal lines. The hole diameter Di1 is 25 μm. The circular holes 351 are disposed in a matrix along the X-axis direction and the Y-axis direction. In both the X-axis direction and the Y-axis direction, the spacing Ph4 and Ph5 between the center points of the circular holes 351 are 40 μm.

The asterisk-shaped microholes 52 of the decorative sheet 20 exemplified in the embodiment are compared with the above-mentioned decorative sheet 321. The first slit 231 to the fourth slit 234 of the asterisk-shaped microhole 52 (see FIG. 5) to be compared have a width W1 to W4 of 30 μm, a length of L1 to L4 of 270 and the distance between the midpoints C1 in the X-axis direction and the Y-axis direction of 300 μm.

The aperture ratio after data conversion is about 37% for the decorative sheet 321 and about 28% for the decorative sheet 20 using the asterisk-shaped microholes 52 (hereinafter referred to as the asterisk-shaped decorative sheet 20). The aperture ratio is the ratio of the total area of the opening portion to the total area of the light passing area Ar1. The aperture ratio after data conversion is the aperture ratio calculated from the data stored in the memory as shown in FIGS. 6 and 7.

The transmittance is about 11% for the decorative sheet 321 and about 14% for the asterisk-shaped decorative sheet 20. The transmittance of the transparent sheet 21 before being processed by the laser beam in the state where the design layer 22 is formed is about 7%.

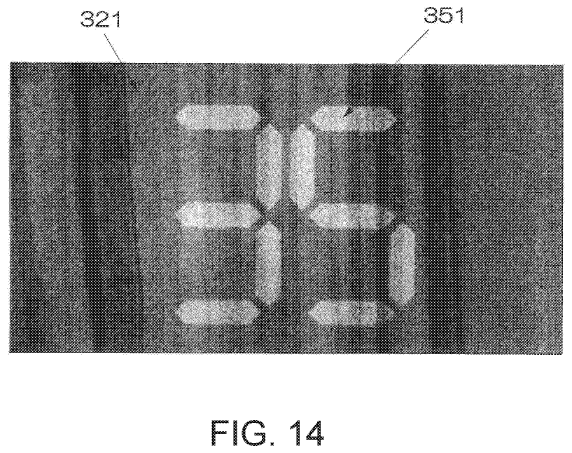

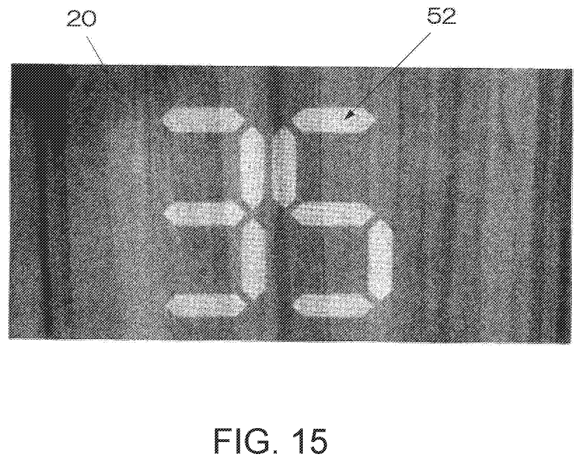

FIGS. 14 and 15 show the decorative sheet 321 and the decorative sheet 20 in a state in which light passes through. A wood grain pattern is printed on the decorative sheet 321 shown in FIG. 14 and the decorative sheet 20 shown in FIG. 15. FIG. 13 schematically shows the cross-sectional structure of the decorative sheet 20 shown in FIG. 15. Although the cross-sectional structure of the decorative sheet 321 is not shown, the decorative sheet 321 has the same cross-sectional structure as the decorative sheet 20 shown in FIG. 13. In the decorative sheet 20 shown in FIG. 13, a transparent resin 24 for forming irregularities is printed on the surface of the transparent sheet 21. The design layer 22 is formed on the back surface of the transparent sheet 21. Patterns 22a and 22b are printed on the design layer 22. An adhesive layer 25 is formed on the surface of the design layer 22 on the opposite side of the transparent sheet 21. The adhesive layer 25 is, for example, a layer to which an adhesive is applied for adhering to the molded body at the time of injection molding simultaneous with decoration forming.

As an evaluation of the design layer 22 in a state in which light does not pass though, the appearance of the asterisk-shaped decorative sheet 20 and the decorative sheet 321 could be commercial products.

In both the decorative sheet 321 shown in FIG. 14 and the decorative sheet 20 shown in FIG. 15, the figures “35,” which is the secondary object, is projected in the wood grain pattern, which is the primary object. Compared with the figures “35” shown in FIG. 14, in the figures “35” shown in FIG. 15, each of the microholes 52 of the light passing area Ar1 configuring the figures is clearly visible. Since the visibility of each microhole 52 is high, the figures “35” is clearly visible. In contrast, since each of the microholes 52 configuring the figures “35” in FIG. 14 is not clear, it seems that the figures “35” and the wood grain pattern in the background are not sufficiently separated.

(6-1)

In addition to the design shown by the design layer 22, the decorative sheet 20 may display a pattern by the multiple microholes 51 and 52. Since each of the microholes 51 and 52 is formed by crossing the first slit 231 and the second slit 232, for example, compared with a pattern displayed by dots such as the circular holes 351, it is possible to increase the brightness of each of the multiple microholes 52 shown in FIG. 15 to improve the visibility of each microhole 52. As a result, for example, the visibility of the pattern displayed by the multiple microholes 52 shown in FIG. 15 may be improved.

Further, the display device 1 provided with such a decorative sheet 20 may leave more design layers 22 in comparison to the sizes of the microholes 51 and 52. For example, the time display of FIG. 1 may be sufficiently displayed while clearly expressing the wood grain pattern shown in FIG. 2.

(6-2)

In the above-mentioned decorative sheet 20, for example, the first slit 231 and the second slit 232 of the microholes 51 and 52 are configured to have a width of 50 μm or less and a length of 500 μm or less, respectively. The decorative sheet 20 configured in this way makes it easy to achieve both improving the visibility of the pattern (secondary object) displayed by the multiple microholes 51 and 52, and suppressing the deterioration of the quality of the design (primary object) of the design layer 22.

(6-3)

Since the light transmittance of the light passing area Ar1 does not become greater than the light transmittance of the light shielding area Ar2 by 10% or more in the decorative sheet 20, good visibility of the primary object such as a wood grain pattern when light does not pass through may be ensured. Further, since the light transmittance of the light passing area Ar1 is greater than the light transmittance of the light shielding area Ar2 by 3% or more, good visibility of the secondary object such as the figures “35” in FIG. 15 displayed by passing light may be ensured.

(6-4)

In the decorative sheet 20, the first slit 231 and the second slit 232 are each linear, and the angle formed by the first slit 231 and the second slit 232 is configured to be 30 degrees or more and 90 degrees or less. The decorative sheet 20 configured in this way tends to leave ink or a vapor deposition film between the first slit 231 and the second slit 232. As a result, deterioration of the quality of the primary object such as the wood grain pattern due to the formation of the microholes 51 and 52 may be suppressed.

(6-5)

In the decorative sheet 20, each of the multiple microholes may be configured to include a third slit in which an ink or a vapor deposition film is not attached so that light passing through the transparent sheet may pass through. In this case, the third slit is linear; the midpoint of the first slit, the midpoint of the second slit, and the midpoint of the third slit are overlapped with each other; and the third slit may be configured such that the angle formed by the first slit and the third slit and the angle formed by the second slit and the third slit are 30 degrees or more and 90 degrees or less. As compared with a case where the microholes 51 formed only by the first slit 231 and the second slit 232 are disposed, in the decorative sheet 20 configured in this way, it becomes easy to reduce interference fringes such as moire and to improve the brightness of each microhole due to the presence of the third slit.

(6-6)

Like the decorative sheet 20 shown in FIG. 5, each of the multiple microholes 52 is configured to include the first slit 231, the second slit 232, the third slit 233, and the fourth slit 234. The first slit 231 to the fourth slit 234 of each microhole 52 are linear, and the midpoint C1 of the first slit 231, the midpoint C2 of the second slit, the midpoint C3 of the third slit, and the midpoint C4 of the fourth slit are overlapped with each other. In each microhole 52, the first slit 231, the second slit 232, the third slit 233 and the fourth slit 234 are configured such that the angle formed by the slits adjacent to each other is 45 degrees. The decorative sheet 20 configured in this way makes it easy to improve the brightness of each of the microholes 52 while reducing interference fringes such as moire due to the presence of the fourth slit 234.

(6-7)

Like the microholes 51 of the decorative sheet 20 shown in FIG. 4, the microholes may be disposed side by side in a zigzag pattern. In the decorative sheet 20 configured in this way, the microholes 51 may be easily disposed at a high density, and it becomes easy to secure a desired light transmittance.

(6-8)

In the decorative sheet 20, the multiple microholes 51 and 52 are disposed side by side in a matrix with distances D1, D2, D3, and D4 shorter than the length L1 of the first slit 231. In this decorative sheet 20, the microholes 51 and 52 are disposed at a high density, and a desired light transmittance may be easily secured.

Although one embodiment of the disclosure has been described above, the disclosure is not limited to the above embodiment, and various modifications may be made without departing from the gist of the disclosure. In particular, the multiple embodiments and modified examples described herein may be combined as desired and as needed.

### REFERENCE SIGNS LIST

1: Display device
20: Decorative sheet
21: Transparent sheet
22: Design layer
51, 52: Microhole
231: First slit
232: Second slit
233: Third slit
234: Fourth slit

To the claims:

1. A decorative sheet comprising:
a transparent sheet; and
a design layer in which a design is shown by an ink or a vapor deposition film attached to the transparent sheet,
wherein the design layer comprises a light passing area in which light passing through the transparent sheet is caused to pass through by a plurality of microholes, and
each of the microholes comprises a first slit and a second slit to which the ink or the vapor deposition film is not attached, and the first slit and the second slit cross each other.

2. The decorative sheet according to claim 1, wherein the first slit and the second slit each have a width of 50 μm or less and a length of 500 μm or less.

3. The decorative sheet according to claim 1, wherein the design layer has a light transmittance of 20% or less in a light shielding area, which is an area other than the light passing area, and
in the light passing area, the microholes are disposed so that the light transmittance is greater than the light transmittance of the light shielding area by 3% or more, but is not greater than the light transmittance of the light shielding area by 10% or more.

4. The decorative sheet according to claim 1, wherein the first slit and the second slit are each linear, and an angle formed by the first slit and the second slit is 30 degrees or more and 90 degrees or less.

5. The decorative sheet according to claim 4, wherein each of the microholes includes a third slit to which the ink or the vapor deposition film is not attached so that light passing through the transparent sheet passes through, and the third slit is linear, and a midpoint of the first slit, a midpoint of the second slit, and a midpoint of the third slit are overlapped with each other, and
an angle formed by the third slit and the first slit and an angle formed by the third slit and the second slit are 30 degrees or more and 90 degrees or less.

6. The decorative sheet according to claim 5, wherein each of the microholes includes a fourth slit to which the ink or the vapor deposition film is not attached so that light passing through the transparent sheet passes through, and the fourth slit is linear, and a midpoint of the first slit, a midpoint of the second slit, a midpoint of the third slit and a midpoint of the fourth slit are overlapped with each other, and an angle formed by adjacent slits of the first slit, the second slit, the third slit, and the fourth slit is 45 degrees.

7. The decorative sheet according to claim 1, wherein the microholes are disposed side by side in a zigzag pattern.

8. The decorative sheet according to claim 4, wherein the microholes are disposed side by side in a matrix with a distance shorter than the length of the first slit.

9. A display device comprising:
the decorative sheet according to claim 1; and
a screen disposed so that irradiated light passes through the decorative sheet.

10. The decorative sheet according to claim 1, wherein the transparent sheet has irregularities formed on a surface opposite to the surface on which the design layer is formed.

11. The decorative sheet according to claim 1, wherein at least one of the first slit and the second slit is curved.

12. The decorative sheet according to claim 4, wherein an end of the first slit and an end of the second slit are overlapped with each other.

13. The decorative sheet according to claim 4, wherein each of the microholes includes a third slit to which the ink or the vapor deposition film is not attached so that light passing through the transparent sheet passes through, and the third slit is linear,
the first slit, the second slit, and the third slit are overlapped with each other at a common point, and
an angle formed by the third slit and the first slit and an angle formed by the third slit and the second slit are 30 degrees or more and 90 degrees or less.

14. The decorative sheet according to claim 13, wherein each of the microholes includes a fourth slit to which the ink or the vapor deposition film is not attached so that light passing through the transparent sheet passes through, and the fourth slit is linear,
the first slit, the second slit, the third slit, and the fourth slit are overlapped with each other at a common point, and
an angle formed by adjacent slits of the first slit, the second slit, the third slit, and the fourth slit is 45 degrees.

15. The decorative sheet according to claim 4, wherein each of the microholes is disposed at an angle different from an angle of the first slit with respect to an X-axis direction.

16. The decorative sheet according to claim 5, wherein each of the microholes is disposed at an angle different from an angle of the first slit with respect to an X-axis direction.

17. The decorative sheet according to claim 6, wherein each of the plurality of microholes is arranged at different angles of the first slit with respect to the X-axis direction.

18. The decorative sheet according to claim 12, wherein each of the plurality of microholes is arranged at different angles of the first slit with respect to the X-axis direction.

19. The decorative sheet according to claim 13, wherein each of the plurality of microholes is arranged at different angles of the first slit with respect to the X-axis direction.

20. The decorative sheet according to claim 14, wherein each of the plurality of microholes is arranged at different angles of the first slit with respect to the X-axis direction.
